(19) United States
(12) Patent Application Publication
(10) Pub. No.: US 2006/0195793 A1
(43) Pub. Date: Aug. 31, 2006

(54) Method for operation of a medical information system

(76) Inventors: Alfons Feihl, Berg (DE); Werner Neuhaus, Furth (DE); Klaus Stockl, Forchheim (DE)

Correspondence Address: SCHIFF HARDIN, LLP;PATENT DEPARTMENT, 6600 SEARS TOWER, CHICAGO, IL, 60606-6473, US

(21) Appl. No.: 11/363,905

(22) Filed: Feb. 28, 2006

(30) Foreign Application Priority Data
Feb. 28, 2005 (DE) 10 2005 009 056.7

(51) Int. Cl. G06F 17/00

(52) U.S. Cl. 715/751

(57) ABSTRACT

A method is provided for operation of a medical information system that comprises automatically generating an overall report from a plurality of individual reports created based on a planning list and transmitted to a data processing device via a telecommunication device, which individual reports comprise data acquired aided by medical-technical apparatuses; forwarding, in a content-dependent manner of the overall report, the overall report at least in part via the telecommunication device to a number of automatically-selected reception locations; and appending a receiver-specific task list to the overall report given its distribution to the reception locations via the telecommunication device.

### BACKGROUND

The invention concerns a method for operating a medical information system, particularly a radiology information system (RIS) and/or an image archiving and communication system (PACS). A medical information system is, for example, known from German patent document DE 101 63 469 A1.

Data acquired with medical-technical apparatuses (for example, x-ray apparatuses) increasingly exists in digital form. A system for processing of digital data in nuclear medicine is, for example, described in “Ein DICOM-basiertes PACS für eine nuklearmedizische Klinik” (M. Laβmann, C. Reiners, electromedica 70, 2002, book 1, pages 21-30), which particularly discusses the transfer of data by means of a DICOM worklist under integration of various medical-technical modalities.

### SUMMARY

The invention is based on the object to further develop the utilization of information processing systems in the health care field, particularly in hospitals.

This object is inventively achieved via a method for operating a medical information system, comprising: automatically generating an overall report from a plurality of individual reports created based on a planning list and transmitted to a data processing device via a telecommunication device, which individual reports comprise data acquired aided by medical-technical apparatuses; forwarding, in a content-dependent manner of the overall report, the overall report at least in part via the telecommunication device to a number of automatically-selected reception locations; and appending a receiver-specific task list to the overall report given its distribution to the reception locations via the telecommunication device.

Various embodiments of the invention are discussed in the following. The methods for operation of a medical information system according to various embodiments assumes that a plurality of individual reports have been generated on the basis of a planning list, and not necessary generated in an automated manner. These individual reports respectively comprise data that were acquired with the aid of a medical-technical device and are transmitted to a data processing device via a telecommunication device. The data processing device automatically generates an overall report from the individual reports. Dependent on the content of the overall report, this is forwarded at least in part to a number of reception locations, whereby a receiver-specific task list is respectively appended to the overall report upon its distribution. If a response report (typically not generated automatically) thereupon arrives in the data processing device from one of the reception locations, the response report is registered (advantageously automatically) using stored templates and inserted at least in part into the overall report.

The planning list from which the method proceeds is advantageously created in the framework of a hospital information system, particularly a radiology information system. The planning list typically comprises subtraction angiography plurality of examinations and/or treatments to be implemented. The corresponding examination or treatment reports generated by experts on the basis of the planning list are automatically consolidated into the overall report. In the simplest case, an examination or treatment report (generally designated as an individual report) can merely be a single image, and in the extreme case, can also be only one measurement value. The overall report is used to distribute further tasks to specialists who, in the individual cases, can be identical with the aforementioned experts. The tasks are normally findings to be created under evaluation of x-ray exposures or other data acquired with arbitrary, particularly imaging, diagnosis apparatuses.

In order to select suitable specialists as recipients of the overall report, the content of the overall report and/or of the content of the individual reports forming the basis of this report is automatically evaluated, for example, via text analysis. The DICOM standard has emerged as advantageous for the handling of the various reports in the medical information system. The automated evaluation of a report, which preferably exhibits XML structures, ensues according to a definable or configurable pattern. A design of a report in template form is hereby particularly advantageous. For example, DICOM headers or query tags defined in DICOM can be evaluated. Independent of the data format used, a search algorithm implemented automatically can refer to keywords in reports, to freely selectable texts or to automatically or manually placed markers.

Each of the selected specialists receives a receiver-specific task list that is appended to the overall report, is integrated into this, or is logically linked with the overall report in another manner. The overall report, expanded by the receiver-specific task list, can also be identical for all receiver locations, whereby it is merely marked which tasks are relevant for which receiver.

In any case it is significant that the automatic selection of the receiver locations has already ensued dependent on the content of the overall report, and therewith also dependent on the individual reports. If a response report sent by one of the receiver locations arrives in the data processing device which is provided for generation of the overall report, the data of the response report can be integrated into the overall report in an unprocessed or processed form. This expanded overall report is advantageously automatically also forwarded to the other reception locations, and therewith to the other experts. Any telecommunication devices operating over wires or wirelessly are suitable for all steps of the data transfer that are described above.

The automatic selection of the reception locations of the overall report is advantageously made under consideration of a know-how profile and/or a time plan of the receiver, particularly of the doctor. In particular the type of the apparatus used for examination of the patient, the examined body region, as well as (if applicable) a preliminary diagnosis are addressed in the algorithm that is used for selection of the receiver. As soon as one of the receivers sends back a response report, preferably at least a short notification is forwarded to the other receivers which informs the individual receivers of the handling of a task, insofar as the entire expanded overall report is not distributed to all receivers. In an advantageous modification, such a notification is already distributed (for example, via e-mail) when a receiver has begun with the processing of a report in order to avoid unnecessary duplicate work. In the individual case, however, it can also be reasonable to obtain multiple opinions regarding one matter. In particular, in such a case, the automatic, simultaneous distribution of the overall report to multiple specialized receivers who can process this report in parallel represents a clear time savings.

xxx In simple cases, the receiver-specific task lists to be extracted from the overall report can implicitly result from the overall report, for example, in that receiver-specific emphases and/or deletions are provided in the overall report. Such an emphasis can, for example, be a color marking of a field to be filled out of a table or another form. Task lists forwarded to the various receiver locations are generally, advantageously designed as forms compatible with the overall report, insofar as they are not integrated into the overall report anyway.

A rational report processing is made particularly easier in that markers (what are known as “tags”) are provided in the report that indicate the relevance of the report or of a part of the report. Such tags can either be placed automatically by way of evaluation of the content of the report or of the appertaining report part or manually by the processor. The automated query of the “relevant” tags represents a particularly simple, objective assistance in the selection of experts for further processing, particularly for medical assessment, which selection occurs via an algorithm that can be executed automatically.

According to an advantageous development, a reference report (which, for example, is stored digitized in a hospital information system) is attached to the overall report, which reference report is automatically selected at least on the basis of an evaluation of the report content. The reference report does not necessarily exhibit the same formatting as the overall report. However, the reference report can be used as a modifiable format template for the overall report. It is likewise possible to store a plurality of blank form templates that can be automatically selected as format templates for the overall report, dependent on the content of the overall report, in particular on the content of the individual reports. Like the reference report or the plurality of automatically-selectable reference reports, the individual reports can also initially exist in a format deviating from the format of the overall report or exist unformatted. In such cases, an automatic format conversion by the data processing system ensues as needed.

The advantage of this approach is particularly that a temporally and qualitatively optimized cooperation of medical experts, for example, radiologists and surgeons, is coordinated in a complex diagnostic and/or therapeutic system (particularly a system with different imaging modalities) with the aid of an automatically-implementable algorithm.

### DESCRIPTION OF THE DRAWINGS

An exemplary embodiment of the invention is subsequently explained in detail according to the following drawing figures.

FIG. 1 is a simplified block diagram of the logical elements of a medical information system; and

FIG. 2 is a block diagram illustrating the information flow in a medical information system in which a plurality of examination and/or treatment devices are integrated.

Parts or parameters corresponding to one another are provided with the same reference characters in both Figures.

### DETAILED DESCRIPTION OF THE PREFERRED EMBODIMENT

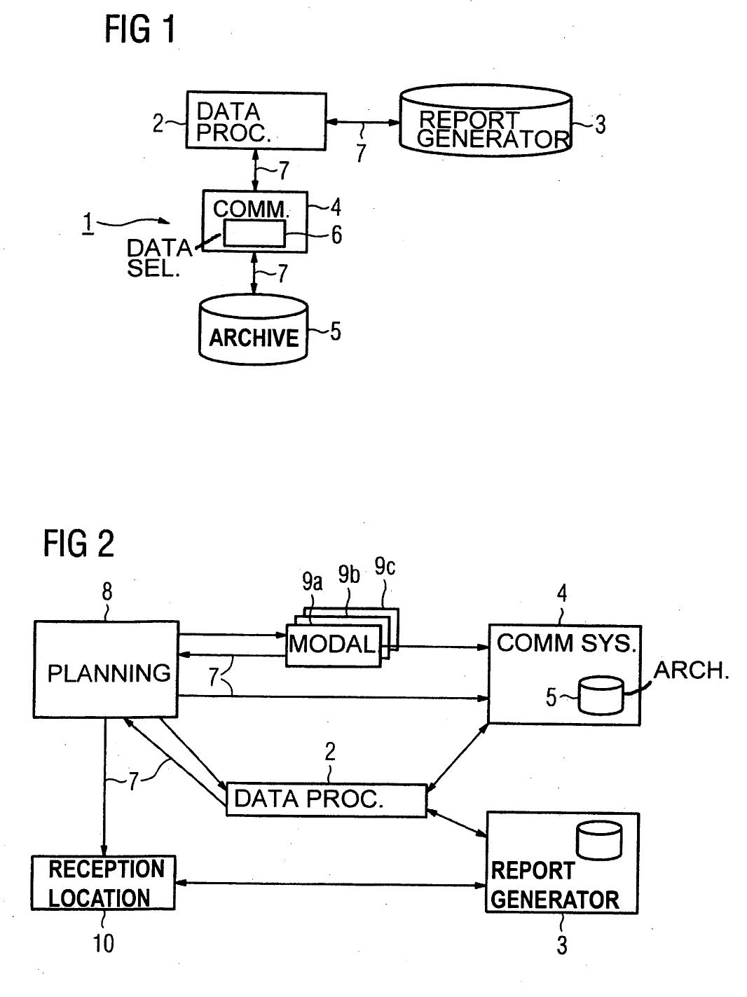

FIG. 1 symbolically shows the design of a medical information system 1, also designated as a hospital information system (HIS). A data processing device 2 (reporting control module) is of central importance for the inventive method. This is linked on the one hand with a report generation module 3 and on the other hand with an image archiving and communication system 4 (PACS). The latter cited system is in turn coupled with a data archive 5.

To establish a logical connection of the data archive 5 with the image archiving and communication system 4, this system 4 comprises a data selection module 6. All of the cited components 2, 3, 4, 5, 6 of the medical information system 1 are not necessarily parts physically separate from one another. Rather, FIG. 1 illustrates merely logical subdivisions of the medical information system 1, whereby individual parts (for example, the data archive 5) can be integrated into further components, for example, the image archive and communication system 4. The function of the reporting control module 2 which realizes the inventive method can also be realized purely as software.

Insofar as individual components of the components 2, 3, 4, 5, 6 of the medical information system 1 are physically separate from one another, a data exchange over arbitrary distances is possible via a telecommunication device 7 (indicated by arrows). The telecommunication device 7 can particularly be realized in the form of a network and be integrated into a superordinate communication network (not shown).

It is the central task of the data processing device 2 to generate and to administer medical reports. For this purpose, the data processing device 2 can access the report generation module 3 in which format templates for medical reports are stored and/or can be generated. The selection of a suitable format template for a report ensues using the image archiving and communication system 4 connected with the data archive 5. The reports stored and processable in the medical information system 1 primarily concern, for example, the field of cardiology. The entries in the reports can be texts that can be freely formulated as well as individual values, for example, the diameter of a heart valve, a wall thickness or a ventricle length. Standardized text blocks can also be provided to the doctor for particularly efficient generation or processing of a report.

The data flow in a medical information system 1 is explained in detail in the following using FIG. 2. Which examinations and/or treatments are to be conducted on a patient is initially established with the aid of a planning module 8, which is part of a radiology information system (RIS). Various diagnosis and/or therapy apparatuses 9a, 9b, 9c (generally also designated as modalities) are necessary for implementation of these examinations and/or treatments. With the aid of the planning module 8, a planning list (worklist) is created that specifies which examinations or treatments are to be implemented via the individual modalities 9a, 9b, 9c. The data (typically image data) acquired in the individual modalities 9a, 9b, 9c are stored in the image archiving and communication system 4 together with associated patient data.

As soon as an examination or treatment on one of the modalities 9a, 9b, 9c has ended, a corresponding message is transferred to the planning module 8. In total, in the present case, three individual reports that respectively concern an examination or treatment on one of the modalities 9a, 9b, 9c are to be created on the basis of the planning list created with the aid of the planning module 8. If all individual reports are present, a corresponding message is transferred from the planning module 8 to the data processing device 2 as well as to the image archiving and communication system 4. As explained in connection with FIG. 1, the planning module 8 also does not necessarily represent a structural unit physically separate from the remaining components of the medical information system 1.

Assembled from the individual reports now present, an overall report is furthermore generated with the aid of the data processing device 2 and the report generation module 3. After the data processing device 2 has received from the RIS planning module 8 the information that the data of all individual reports (meaning the results of the examinations implemented via the modalities 9a, 9b, 9c) are complete, under access to the image archiving and communication system 4 the data processing device 2 starts a search for comparable, already-concluded cases. For example, the type of the modalities 9a, 9b, 9c used as well as information about the examined body region of the patient and, if applicable, about pre-existing conditions are hereby evaluated.

The DICOM standard (digital image communication in medicine) is advantageously used for the transfer and processing of the data of the individual reports as well as the archived processes. Data particularly exist in templates (forms) as a DICOM SR (structure report). Among other things, what is known as the SOP (service-object pair) class UID can hereby be evaluated. Moreover, a full text evaluation of stored reports as well as of the new individual reports advantageously occurs. For example, terms for examined body parts are sought in the reports in the framework of such an automatic evaluation. For example, it is likewise possible to search summaries of reports for keywords.

In each case, individual past cases that approximate the current case processed according to the planning list are automatically selected from the database of the image archiving and communication system 4. Various search criteria are hereby logically, hierarchically organized in the manner of a fallback list, whereby the organization criteria can be influenced by the user.

Even in cases in which the user does not engage in the search algorithm, this is automatically optimized via the continuous evaluation of collected data in the course of time. It is thus a self-learning system which already makes the medical assessment easier in that the data of reference cases are provided with increasing effectiveness. However, the self-learning properties of the medical information system 1 are related not only to the linking of a current case with archived comparison data, but rather also to the automatic suggestion as to which experts should be consulted for generation of a finding or for handling of other tasks, for example, for implementation of further examinations and/or treatments. The medical information system 1 moreover has the advantage that the structured, administered data (that particularly concern examinations implemented with the modalities 9a, 9b, 9c) can also be used particularly effectively for purposes of research and teaching.

After it has received the individual reports via the telecommunication device 7, the data processing device 2 also establishes a connection with the report generation module 3. As with the linking (explained above) with the image archiving and communication system 4, this process also has the purpose to obtain data that enable a rational further processing of the individual reports.

In the case of the report generation module 3, this concerns various format templates for the overall report in which the individual reports are combined in an unchanged version or—advantageously—in an automatically-processed version, particularly in a version structured in template form. If a suitable format template is selected from the report generation module 3 or automatically generated via this module, the data of the individual reports are transferred in this format template and the overall report is therewith generated. The overall report advantageously exhibits a formatting as it was already used in the same or a similar manner in earlier cases documented via the image archiving and communication system 4.

The overall report is to be used by medical experts in order to generate a finding. In principle, various experts (typically from different fields of expertise) are available for the generation of the finding. Providing the entire report (which is possibly unnecessary in the individual case) to each of these experts should be avoided. For this purpose, an automatic selection of the recipients ensues, whereby the (automatically evaluated) content of the overall report (as well as, if needed, also the content of the planning report on whose basis the examinations whose results were entered into the overall report were conducted) is adapted with stored profiles of the experts who are available in principle.

The profiles of the individual experts (predominantly doctors) in particular comprise know-how profiles as well as time plans. Examination-specific features, such as designations of organs, are typically associated with specific examination experts. The frequency of technical medical terms occurring in a report is also hereby automatically evaluated. Furthermore, it is evaluated to what extent a specific expert has generated or processed reports of a specific type in the past. For example, if an expert has already rejected the processing of a report of a specific type, in the future, a lower priority is associated with this expert in the processing of similar reports, whereby ultimately a removal of this doctor from the list of experts is also possible. It is likewise possible to additionally incorporate experts who, for example, demonstrate newly acquired special knowledge into the expert lists, which are therewith continuously adapted to the actual conditions. In a corresponding manner, the data stored in the data processing device 2 are continuously adapted to the actual conditions via the available medical-technical modalities.

A specific task is associated with each of the automatically-selected doctors or other experts. A corresponding receiver-specific task list is appended to the overall report, which therewith exists as an expanded overall report in various versions. The various expanded overall reports are transferred from the data processing device 2 to the planning module 8 in order to be forwarded to various reception locations 10, of which only a single locations that is associated with a medical specialist is exemplarily shown. The reception locations 10 are linked with the report generation module 3 and therewith also with the image archiving and communication system 4, such that a format template newly generated or modified for an overall report is also usable for a future finding.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for operating a medical information system, comprising:
automatically generating an overall report from a plurality of individual reports created based on a planning list and transmitted to a data processing device via a telecommunication device, which individual reports comprise data acquired aided by medical-technical apparatuses;
forwarding, in a content-dependent manner of the overall report, the overall report at least in part via the telecommunication device to a number of automatically-selected reception locations; and
appending a receiver-specific task list to the overall report given its distribution to the reception locations via the telecommunication device.

2. The method according to claim 1, further comprising:
automatically registering a response report arriving in the data processing device via the telecommunication device and sent from a reception location; and
inserting at least part of the response report into the overall report.

3. The method according to claim 1, wherein a selection of the reception locations is made utilizing a know-how profile of the respective receiver.

4. The method according to claim 1, wherein a selection of the reception locations is made utilizing a time plan of the respective receiver.

5. The method according to claim 1, wherein at least one of the overall report and the at least one task list is distributed in the DICOM standard via the telecommunication device.

6. The method according to claim 1, further comprising:
automatically generating a notification to at least one further reception location upon input in the data processing device of a response report sent from a reception location.

7. The method according to claim 1, further comprising:
forwarding the overall report in various versions to the individual reception locations, whereby at least one of respective receiver-specific emphases and deletions are provided.

8. The method according to claim 1, further comprising:
generating task lists forwarded to various reception locations in a format compatible with the overall report.

9. The method according to claim 8, wherein the overall report generated via the data processing device is automatically created in a structured form, at least partially from unstructured individual reports or individual reports existing in different formats.

10. The method according to claim 1, further comprising:
automatically attaching at least one reference report selected based on an evaluation of the individual reports to the overall report distributed via the telecommunication device.

11. The method according to claim 10, further comprising:
automatically incorporating contents of at least one unstructured reference report or reference report existing in a format deviating from the overall report into the overall report in a structured form via the data processing device.

12. The method according to claim 8, wherein the overall report generated via the data processing device is created in a form format, whereby empty fields are provided for a standardized insertion of at least one response report.

13. The method according to claim 8, further comprising:
automatically selecting a format template of the overall report from a plurality of form templates via the data processing device, dependent on the individual reports.

14. The method according to claim 13, further comprising:
automatically changing the format template selected for creation of the overall report dependent on content of at least one of the individual reports and reference reports.

15. The method according to claim 1, wherein parts of the overall report exhibit a manually-inserted or automatically-generated relevance classification.

16. The method according to claim 1, further comprising:
determining the relevance classification via evaluation of at least one of the individual reports and reference reports via the data processing device.
